(19) United States
(12) Patent Application Publication
(10) Pub. No.: US 2009/0253309 A1
(43) Pub. Date: Oct. 8, 2009

(54) FIELD ATTACHABLE POWER CONNECTOR

(76) Inventor: Robert G. Didier, Santa Rosa, CA (US)

Correspondence Address: Vierra Magen Marcus & DeNiro LLP, 575 Market Street, Suite 2500, San Francisco, CA, 94105, US

(21) Appl. No.: 12/098,978

(22) Filed: Apr. 7, 2008

(51) Int. Cl. H01R 13/502

(52) U.S. Cl. 439/686

(57) ABSTRACT

A cable connector system includes a first set of contacts fixed in a housing and a second set of contacts fixed in a replaceable nose section. The second set of contacts is configured to mate with a standard power receptacle, for example, on an aircraft. Advantageously, a third set of contacts is fixed in an intermediate section, wherein the third set of contacts is adapted to mate the first set of contacts with the second set of contacts.

### BACKGROUND

This disclosure relates to electrical cable connectors, and more particularly, to a heavy duty cable connector system suitable for providing ground power to aircraft, where the cable connector system includes a replaceable front contact portion.

Most aircraft are equipped with power connectors, such as a male plug receptacle recessed into a cavity of the aircraft for protection, for receiving ground power, such as 400 Hz three-phase electrical power at 200 VAC. Ground power is then supplied by a power cable having a female connector that mates with the male receptacle. The female connector is generally standardized by adherence to U.S. Military Specification MIL C-7974. However, the female connector is subjected to considerable abuse from abrasion due to falls against the concrete or asphalt surfaces on which the aircraft is located as well as degradation and wear due to exposure to weather and petroleum products. This can lead to a loss of “gripping power” for the female connector which causes the connector to come loose and fall out of the aircraft receptacle.

In one attempt to minimize the loss of gripping power in the female connector and the problem of wear generally, alternative designs added a replaceable nose section, wherein an additional set of contacts is integrally molded into a small extension portion, or nose piece, that is connected to the front of the existing connector. These additional contacts mate with the original contacts which are molded into the connector body as well as with the aircraft plug receptacle. See, for example, U.S. Pat. No. 4,758,175 and U.S. Pat. No. 5,256,081, by the same inventor herein, which are expressly incorporated by reference. Therefore, the nose section may be replaced when worn out, rather than the entire connector assembly, and standard replaceable nose sections are available from BIW Connector Systems, Inc.

Another solution to reduce wear and minimize the loss of gripping power is described in U.S. Pat. No. 5,941,718, by the same inventor herein, which is expressly incorporated by reference. In this design, replaceable contacts extend from the body and are screwed into the contacts in the connector body. A cover with througholes corresponding to the replaceable contacts is fitted over the contacts and connected to the body. When the extended contacts and/or the cover wear out, they are removed and replaced as necessary. These field attachable devices are available from DOM Systems Inc. (Model 31-1000 and 31-2000 series).

Notwithstanding the foregoing, it remains desirable to obtain improved cable connector assemblies that minimize costly replacement of component parts.

### SUMMARY

A heavy duty cable connector system having replaceable contacts is disclosed. A fully integrated and sealed molded housing is formed to include a molded contact body that holds a first set of contacts. The first set of contacts is connected within the housing to a plurality of conductors from a cable. The cable is inserted into the housing and sealed through a grommet.

A replaceable nose section includes a second set of contacts which are configured to mate with a standard power receptacle, for example, on an aircraft. An intermediate section includes a third set of contacts which are adapted to mate the first set of contacts with the second set of contacts. The intermediate section can thus be configured to mate any two types of contacts thereby allowing for different types of contact bodies and replaceable nose sections.

A further understanding of the nature and advantages of the device disclosed herein may be realized by reference to the complete specification and the drawings herein.

### BRIEF DESCRIPTION OF THE DRAWINGS

FIG. 1 illustrates an exploded perspective view of a known aircraft power cable connector arrangement.

FIG. 2 illustrates an exploded perspective view of a new aircraft power cable connector arrangement.

FIG. 3A illustrates a front plan view of the housing portion of the connector shown in FIG. 1, and FIG. 3B is a side plan sectional view taken through section 3B-3B of FIG. 3A.

FIG. 4A illustrates a front plan view of the molded contact body portion of the connector shown in FIG. 1, and FIG. 4B is a side plan sectional view taken through section 4B-4B of FIG. 4A.

FIG. 5A illustrates a front plan view of the nose section portion of the connector shown in FIG. 1, and FIG. 5B is a side plan sectional view taken through section 5B-5B of FIG. 5A.

FIG. 5C illustrates a front plan view of the nose section portion of the connector shown in FIG. 2, and FIG. 5D is a side plan sectional view taken through section 5D-5D of FIG. 5C.

FIG. 6A illustrates a front plan view of the intermediate portion of the connector shown in FIG. 2, and FIG. 6B is a side plan sectional view taken through section 6B-6B of FIG. 6A.

### DETAILED DESCRIPTION

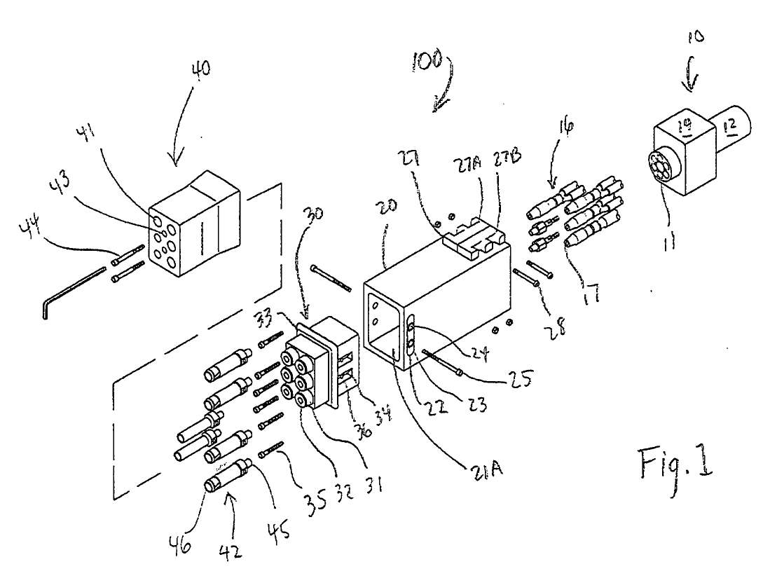

FIG. 1 illustrates a known cable connector assembly 100 that is commonly used for providing ground power to aircraft. A jacketed cable 10 is connected through a housing 20 to a molded contact body 30, and a replaceable nose section 40 is coupled with the contact body 30, as further described below. A standard connector configuration for aircraft power applications includes power contacts labeled A, B, C and N and control contacts labeled E and F, as shown on the front of nose section 40.

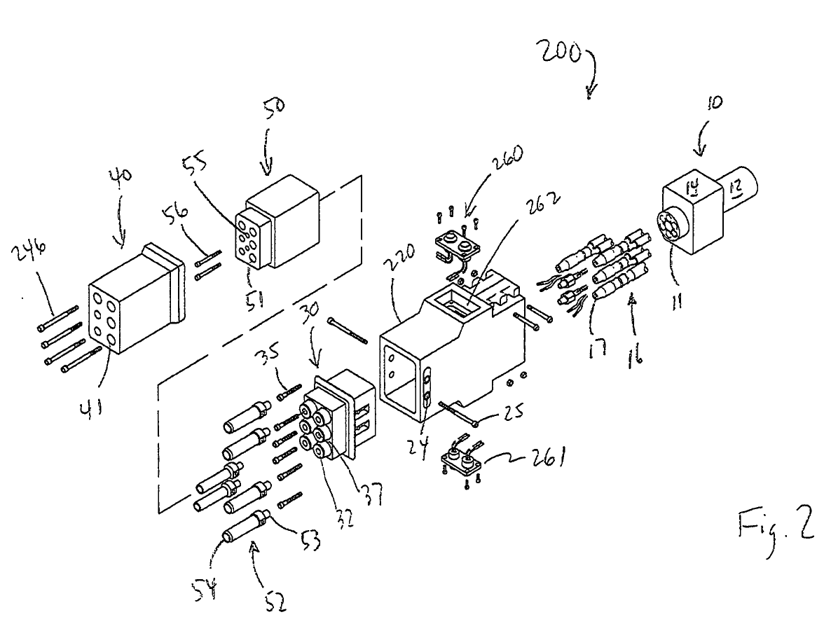

FIG. 2 illustrates an improved cable connector assembly 200, wherein an intermediate section 50 is utilized between the contact body 30 and the replaceable nose section 40. Advantageously, the intermediate section 50 may be configured to mate with any type of replaceable nose section or contact body. Further, the intermediate section may be configured to utilize the cap screws from the detachable nose to attach the intermediate to the molded body. Particularly advantageous is the fact that a user may continue to utilize an existing inventory of replaceable nose sections even after changing out the type of contact body utilized in the system by incorporating a properly configured intermediate section.

Referring back to the known cable connector assembly of FIG. 1, the cable 10 includes a plurality of conductors 11 contained within a single insulated cable jacket 12. For example, a preferred standard aircraft cable includes six conductors (e.g., #2 AWG) wrapped in a helix around one larger central conductor (e.g., #1 AWG) and housed within an insulated sheath. The central conductor provides power to the N contact of the standard receptacle, and the other six conductors are grouped in opposing pairs (e.g. 180 degrees apart) and used to provide power to the A contact, the B contact and the C contact, respectively. Two other small conductors (e.g. #12 AWG) are contained within the insulated sheath and are connected to the circuit breaking relay contacts E and F.

A grommet 14 is installed a short distance from a clean cut end on the cable 10. Each of the wires 11 in cable 10 is stripped and connected to the end of respective conductive barrels 16, for example, by crimp or solder. Each of the conductive barrels 16 has a threaded tubular opening 17 adapted to receive the threaded end of cap screw 35, as described below. Further, the conductive barrels 16 may have different sizes as necessary to mate with different conductor/contact sizes. Advantageously, all the barrels 16 and threaded openings 17 may be the same size and the cap screws 35 may be the same length to facilitate ease of assembly. It may be desirable to cover the connections, for example, with insulated heat shrink tubing.

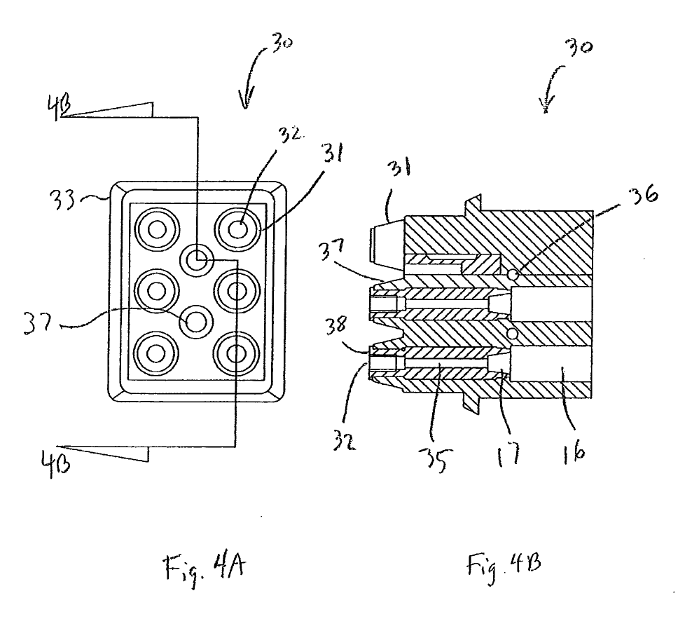

A molded body 30 is provided to receive and contain contacts, namely the conductive barrels 16. Additional details of the molded body 30 are provided in FIG. 4A, which shows a head-on plan view of the body, and FIG. 4B, which shows a side plan sectional view of the body. The molded body 30 may be formed of flexible rubber or similar material to have annular projections 31 with central openings 32 on the front of the body. The central openings 32 include a threaded portion 38 (see FIG. 4B) on the inside portion of the projections 31. The body 30 also includes a flange 33 and cylindrical througholes 34 through the body in correspondence with each of the openings 32 in annular projections 31. The barrels 16 and connected wires 11 are installed as contacts in the molded body 30, for example, placed by hand, inside of cylindrical througholes 34 of the body such that the threaded receptors 17 of the contacts 16 are accessible through the larger threaded openings 32 in the annular projections 31 (see FIG. 4B). The contacts/barrels 16 are then secured in place by placing cap screws 35 through the contact openings 32 and tightening the cap screws into the threaded openings 17 of each barrel 16. Note that the threaded portion 38 of openings 32 are formed to be larger than the cap screws 35 and therefore are not engaged by the cap screws. The cap screws 35 are inserted through the openings 32 such that the threaded portion 38 of the openings 32 remain available for engagement by the male threaded ends 45 of contacts 42, as described below. As shown in FIG. 4B, the cap screw 35 is actually recessed within the opening 32. The molded body 30 also has a pair of lateral holes 36 formed through the body as a means for the body to be secured to the housing 20 with standard screws or fasteners. Further, threaded inserts 37 (see FIGS. 4A and 4B) are formed in a central portion of the body 30 to receive cap screws 44, as described below.

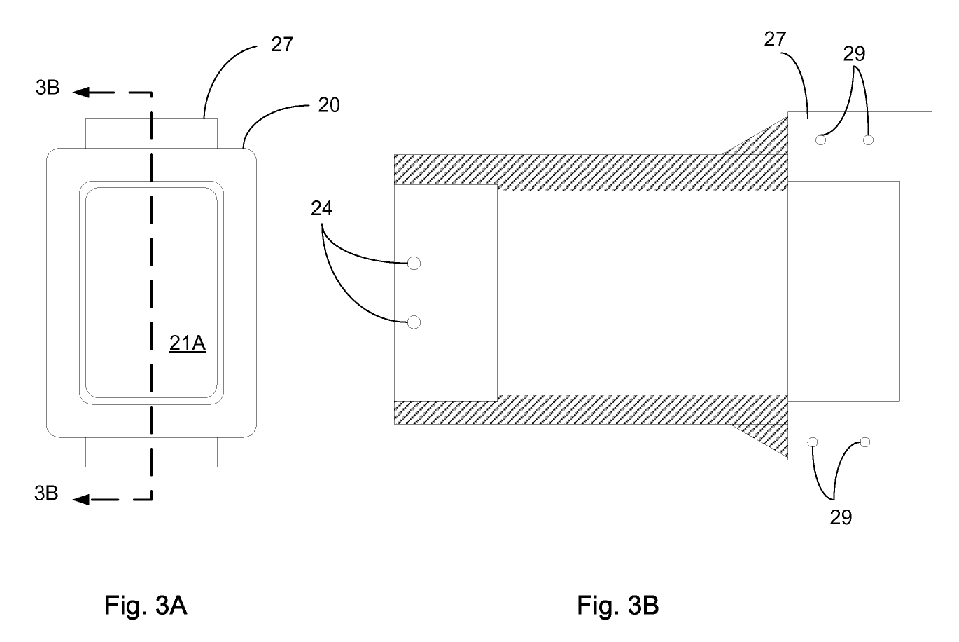

The housing 20, also formed of molded rubber or similar material, has an opening 21a on one end thereof to receive the molded body 30 until stopped by the flange 33. Additional details of the housing 20 are provided in FIG. 3A, which shows a head-on plan view of the housing, and FIG. 3B, which shows a side plan sectional view of the housing. The housing 20 includes a pair of lock plate assemblies 22 formed on opposing sides of the housing near the opening 21a. Each lock plate assembly 22 includes a steel plate 23 having two threaded holes 24. The molded body 30 is secured within the housing 20 by caps screws 25 fitted through holes 24 in the lock plates 22 and lateral holes 36 in the molded body.

The housing 20 also includes a pair of grommet sealing structures 27 affixed to opposing sides of the housing. The structures 27 are molded rubber and formed in two parts 27a, 27b as part of the housing 20. The grommet 14 is slid into the rear opening of the housing 20, and screws/nuts 28 are installed through holes 29 in structure 27 and tightened to secure the cable 10 and grommet 14 to the housing 20. In an alternate embodiment, the grommet 14 and sealing structures 27 may be eliminated and the assembled connector may be potted using a quick-setting rubber compound to seal the cable to connector termination. The quick-setting rubber should have properties similar to the housing. This alternative will typically be used for multiple cable configurations.

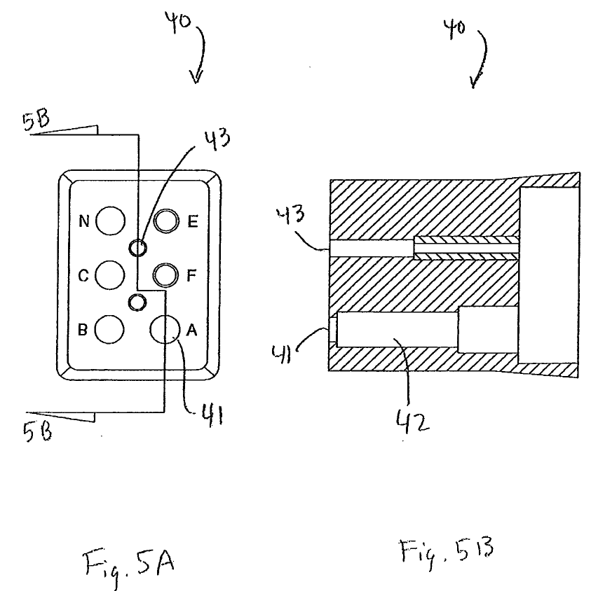

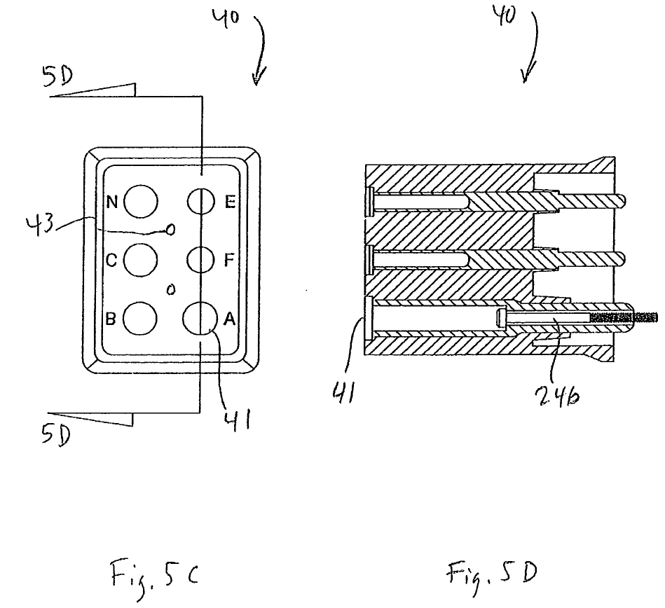

A detachable nose section 40 couples to the molded body 30. Additional details of the nose section 40 are provided in FIGS. 5A-5D. The nose section 40 is formed of molded hard rubber or equivalent material and includes first througholes 41 for accommodating contacts 42 and second througholes 43 for accommodating cap screws 44. The contacts 42 have male threaded ends 45 that are screwed into the threaded openings 32 of the molded body 30. The contacts 42 also have female ends or barrels 46 that mate with the male pins in the connector receptacle provided on the aircraft (not shown). A pair of cap screws 44 are inserted through the second througholes 43 and tightened into the threaded inserts 37 of the molded body 30 to secure the nose section 40 to the body. The second througholes 43 have recessed shoulders such that cap screws 44 seat snugly against the nose section 40. All cap screws may be secured using a single Allen wrench.

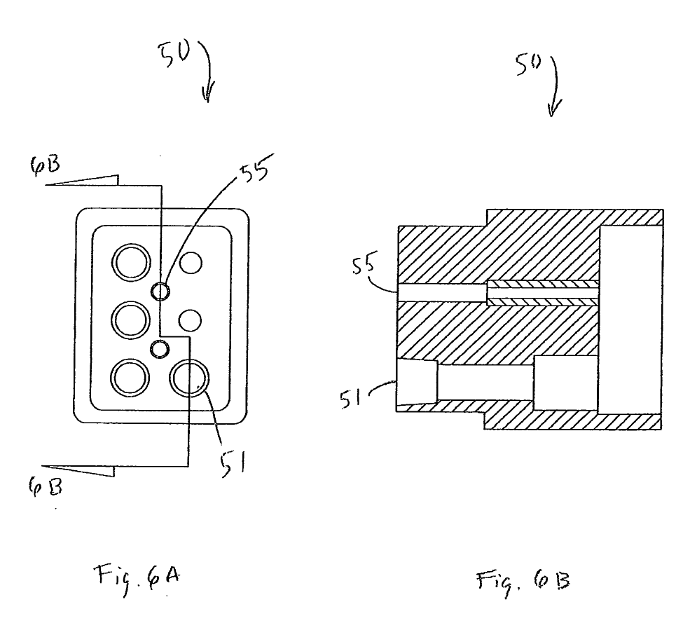

Referring now to FIG. 2, an improved cable connector assembly 200 is illustrated. As previously noted, the cable connector assembly 200 includes an intermediate section 50 fitted between the molded contact body 30 and the replaceable nose section 40. Additional details of the intermediate section 50 are provided in FIGS. 6A-6B. In most respects, the connector assembly 200 may be identical to the connector assembly 100 shown in FIG. 1, and thus the use of the same numbering on FIG. 2 indicates the same part as shown in FIG. 1, and redundant descriptions thereof will be omitted. Further, although the housing 220 shown in FIG. 2 includes waterproof switch assemblies 260, 261, the housing 20 without switch assemblies as shown in FIG. 1 could also be used. The switch assemblies 260, 261 are mounted in pre-formed housing openings 262, 263, respectively, using standard fasteners, and have switch contacts connected to separate wires contained within the insulated sheath 10 to provide separate control functions, such as on/off for the main circuit breaker, or up/down for a motorized cable reel, or perhaps an indicator light to show that power is on.

The intermediate section 50 is formed of molded rubber and includes formed openings or througholes 51 corresponding to each of the contacts. After the tubular contacts 16 are fitted within the molded contact body 30 and secured by tightening cap screws 35 into the threaded openings 17 of contacts 16, as described above, another complete set of contacts 52 is incorporated within througholes 51 of the intermediate section 50. Each of the four power contacts 52 is hollow and has a threaded male end 53 that is configured to mate with the threaded opening 32 of the molded contact body 30, and a female end 54 that is configured to receive the male end 45 of corresponding front contact 42 contained in the nose section. The inside of the female end 54 of each power contact 52 is also threaded to receive a large (quarter-inch) cap screw 246, which is routed through the body of the hollow power contact 42 in througholes 41 (rather than through central openings 43 as in FIG. 1) to secure the nose section 40 to the intermediate section 50. The intermediate section 50 also includes a pair of central openings 55 through which cap screws 56 extend to secure the intermediate section to the central threaded inserts 37 of the molded body 30. The relay contacts E and F are generally too small to be held by cap screws routed through the contacts, so these contacts are secured by being held in place when the nose section 40 is otherwise secured to the intermediate section 50.

It may be seen that the contacts 52 of the intermediate section 50 may be configured to mate with any type of molded body and any type of nose section. Since the BIW replaceable nose section is in common use, a common form of the intermediate section will mate with the BIW nose section.

In general, those skilled in the art to which this disclosure relates will recognize that many changes in construction and materials as well as widely differing embodiments will suggest themselves without departing from the spirit and essential characteristics of this disclosure. For example, existing conductors and connectors come in a variety of shapes and sizes. Accordingly, the disclosures and descriptions herein are intended to be illustrative, and not limiting, of the scope of the invention, which is set forth in the claims.

I claim:

1. In a ground power cable connector system having a set of conductors coupled to a first set of contacts in a molded contact body such that a receptor end of each of the first set of contacts is accessible for mating contact, wherein a second set of contacts and a cover section are removably attached to the first set of contacts and the contact body, respectively, the improvement comprising an intermediate section removably attached between the contact body and the cover section, said intermediate section having a third set of contacts configured to mate with said first and second sets of contacts.

2. A ground power cable connector system as in claim 1, wherein each of the third set of contacts has a threaded stud and a threaded receptor, each of said threaded studs adapted to mate with a corresponding threaded opening formed in the molded contact body in line with respective first contact, and wherein each of the second set of contacts has a threaded stud adapted to mate with the threaded receptor of a corresponding third contact.

3. A ground power cable connector system as in claim 2, wherein each of the threaded receptors of the first contacts are the same size.

4. A ground power cable connector system as in claim 1, further comprising a first set of fasteners configured to removably attach the cover section or the intermediate section to the contact body.

5. A ground power cable connector system, comprising:
a housing holding a first set of contacts accessible from one side of the body and a cable containing a first set of conductors, wherein each of the first set of conductors is connected to a corresponding one of the first set of contacts;
a replaceable nose section having a second set of contacts, wherein each of the second set of contacts includes a first end configured to mate with a power receptacle; and
an intermediate section having a third set of contacts configured to mate the first set of contacts with the second set of contacts.

6. A ground power cable connector system as in claim 5, wherein the intermediate section is replaceable.

7. A ground power cable connector system as in claim 5, further comprising:
a first opening and a second opening formed in the housing;
a grommet affixed within the first opening and providing a sealed entrance into the housing for the cable; and
a contact body affixed within the second opening and having the first set of contacts held therein.

8. A ground power cable connector system as in claim 5, further comprising at least one control switch incorporated into the housing.

9. A ground power cable connector system, comprising:
a cable having a plurality of conductors;
a first set of contacts, wherein each of the first set of contacts has a terminal end coupled to one of said conductors and a receptor end having a threaded opening;
a housing holding the first set of contacts in place and having openings to provide access for mating contact with the receptor ends of the first set of contacts;
wherein the cable and first set of contacts are rigidly affixed with the housing;
a replaceable nose section having a second set of contacts disposed in bores through the nose section, wherein each of the second set of contacts has a first end configured to mate with a power receptacle and a second end; and
a replaceable intermediate section having a third set of contacts disposed in bores through the intermediate section, wherein the third set of contacts is configured to mate the first set of contacts with the second set of contacts.

10. A ground power cable connector system, comprising:
a cable having a plurality of conductors;
a first set of contacts, wherein each of the first set of contacts has a terminal end coupled to one of said conductors and a receptor end having a first threaded opening;
a body having a plurality of bores formed through the body, a plurality of second threaded openings formed in correspondence with the bores on a front end of the body, and at least one third threaded opening formed in a central portion on the front end of the body, wherein each of the second threaded openings is larger than the corresponding first threaded openings on the first set of contacts, and wherein each of the first set of contacts is fixed within a respective bore;
a first set of cap screws sized to fit through the second threaded opening and engage the first threaded opening;
an intermediate section having a plurality of bores formed through the intermediate section in correspondence with the bores through the body, and at least one throughhole formed through the intermediate section in a central portion of the intermediate section;
a third set of contacts each fixed within a respective bore of the intermediate section, wherein each of the third set of contacts is hollow and has a male threaded end adapted to engage the second threaded opening and a female threaded end;
a nose section having a plurality of bores formed through the nose section in correspondence with the bores through the body and intermediate section;
a second set of contacts disposed in the bores through the nose section, wherein each of the second set of contacts has a male end configured to mate with the female end of the third contacts and a female end configured to mate with a power receptacle; and
a second set of cap screws sized to fit through the second set of contacts and engage the first threaded opening.
